(19) United States
(12) Patent Application Publication
(10) Pub. No.: US 2006/0279070 A1
(43) Pub. Date: Dec. 14, 2006

(54) Wheel assembly for baby stroller

(75) Inventor: Hung-Chung Hou, Tai-Bau City (TW)

Correspondence Address: BIRCH STEWART KOLASCH & BIRCH, PO BOX 747, FALLS CHURCH, VA, 22040-0747, US

(73) Assignee: Link Treasure Limited, Tortola (VG)

(21) Appl. No.: 11/447,165

(22) Filed: Jun. 6, 2006

(30) Foreign Application Priority Data
Jun. 9, 2005 (TW) 094209603

(51) Int. Cl. B62B 9/00

(52) U.S. Cl. 280/643

(57) ABSTRACT

A wheel assembly for baby stroller has its rotating shaft rod on a central axis along which the shock absorbing compression spring moves. In this way, the wheel assembly is not only capable of having shock absorbing function by making use of the compression spring but is also capable of being not affecting the rotating effect of the wheel assembly.

### BACKGROUND OF THE INVENTION

1. Field of the Invention

The invention relates to a wheel assembly for baby stroller, and more particularly, to a wheel assembly for baby stroller by making use of a special combination of the shaft-connecting member and the resilient element to make the wheel assembly achieve the effects of rotating with respect to a same central axis as a direction of the resilient element moves along and having a shock absorbing function.

2. Description of the Prior Art

In the ordinary baby stroller, for the sake of making the baby sitting therein feel comfortable, in addition to add a resilient form rubber on the seat cushion, a shock absorbing device is also equipped at the lower end of the foot-tube of the frame of the baby stroller. This is to provide the baby stroller to sustain the baby's weight and absorb shock due to the blockade that the baby stroller may come across on the road surface when the baby stroller is pushed around so that the baby stroller can provide the effect of comfort. Moreover, in order to facilitate the operator to control the baby stroller while he/or she is pushing the baby stroller around, normally the wheel assembly is designed to be able to rotate 360 degree of angle. The shock absorbing device of a baby stroller of the prior art like the U.S. Pat. No. 5,581,643 has its structure mainly secures the wheel seat at the end of the foot-tube, and makes the pivot seat, having its two side connect to the wheels pivotally, connected to the wheel seat. What is more, an extension spring is provided between the pivot seat and the wheel seat to achieve the function of absorbing the gravitational force and resisting the shock when the pivot seat is subjected to gravitational force or the pivot seat runs into a blockade. To achieve the shock absorbing function by making use of this type of extension spring can result in rupture of the spring after the extension spring is used for a long time. Moreover, the wheel seat of U.S. Pat. No. 5,276,941 of the prior art is capable of pivotally connecting to a center shaft to make the wheel seat rotate freely. Besides, a compression spring is provided along a center line that is offset a certain distance away and parallel to the rotating shaft to achieve the effects that the wheel assembly is capable of rotating and shock absorbing. But it is the design that the moving center-line of the compression spring is parallel to the rotating center-line will affect the rotating effect of the wheel assembly when the shock absorbing effect is in action.

### SUMMARY OF THE INVENTION

In order to resolve the above-mentioned problems that using an extension spring is subject to rupture and is apt to affect the rotating effect of the wheel seat, the baby stroller of the invention mainly has its rotating shaft rod and the moving direction of the shock absorbing compression spring keep on same central axis such that the wheel assembly is not only capable of having shock absorbing function by making use of the compression spring, but is also capable of being not affecting the rotating effect of the wheel assembly. The baby stroller of the invention mainly includes a connecting seat, a shaft-connecting member, a resilient element, and a wheel seat wherein the connecting seat is connected to the lower end of the foot-tube and having a shaft sleeve that is perpendicular to the ground surface. By the use of the shaft sleeve, the baby stroller is capable of positioning and pivotally connected to the shaft-connecting member. The shaft-connecting member having a shaft rod and a pivotally connecting portion is capable of pivotally connecting to the wheel seat by the use of the pivotally connecting portion that is offset from the position of the shaft rod. Moreover, the fact that a compression resilient element is provided between the shaft rod of the shaft-connecting member and the wheel seat makes the wheel seat capable of not only rotating with respect to the central axis of the shaft rod but also absorbing the sustained shock force. Therefore, the baby stroller of the invention is capable of achieving the effect of rotating and shock absorbing.

The accomplishment of this and other objectives and the range of suitability of the application of the invention will become apparent from the following description and its accompanying drawings of which:

### BRIEF DESCRIPTION OF THE DRAWINGS

FIG. 1 is a schematic front view of the wheel assembly installed in the frame of the stroller of the invention;

FIG. 2 is a schematic and exploded view of the components of the wheel assembly of the invention;

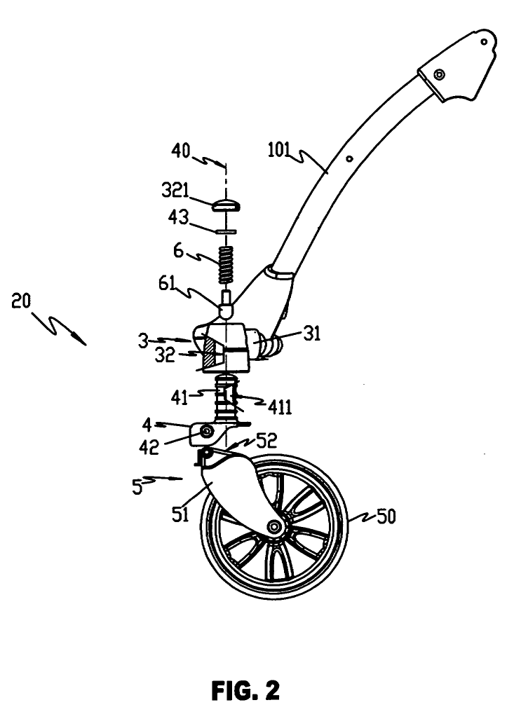

FIG. 3 is a schematic and cross-sectional view of the wheel assembly of the invention;

FIG. 4 is a schematic diagram showing the rotation and the shock absorbing action of the invention;

### DETAILED DESCRIPTION OF THE PREFERRED EMBODIMENT

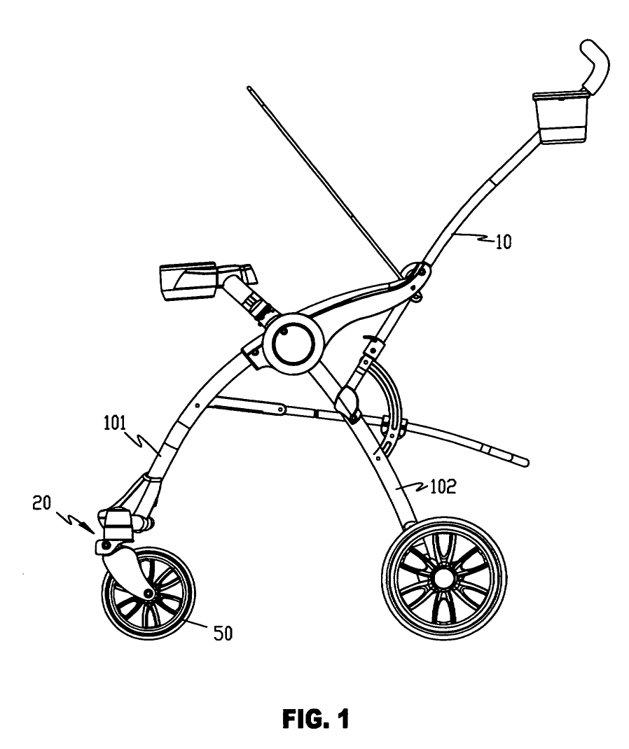

As shown in FIG. 1, 2, and 3, the wheel assembly for baby stroller of the invention is installed in either the front foot-tube (101) or the rear foot-tube (102) of a frame (10) of baby stroller for operator to push around. The wheel assembly (20) includes a connecting seat (3), a shaft-connecting member (4), a wheel seat (5), and a resilient element (6).

The connecting seat (3) for shaft-connecting to wheel (50) of the baby stroller further includes a connecting portion (31) and a shaft sleeve (32).

The connecting portion (31) is connected and secured to the lower end of either the front foot-tube (101) or the rear foot-tube (102), and the shaft sleeve (32) being appeared as a circular slot is longitudinally upright and perpendicular to the ground surface. In the present embodiment, a cap (321) is provided at the top of the shaft sleeve (32).

The shaft-connecting member (4) further includes a shaft rod (41) and a pivotally connecting portion (42). The shaft rod (41) is extended vertically up from the main body of the shaft-connecting member (4) in order that the shaft rod (41) is pivotally connected to the inner portion of the shaft sleeve (32). The pivotally connecting portion (42) is provided such that it is offset a certain distance away from the centerline (40) of the shaft rod (41). In the present embodiment, the shaft rod (41) passes through the shaft sleeve (32) to make the shaft-connecting member (4) pivotally connect to and position in the shaft sleeve (32) by the use of positioning elements (43) such as a C-ring or securing washer and a screw nut etc. Besides, the inner portion of the shaft rod (41) provides a containing slot (411).

The wheel seat (5) being pivotally connected to the pivotally connecting portion (42) makes itself follow the shaft rod (41) of the shaft-connecting member (4) and rotate with respect to pivotally connecting portion (42). In the present embodiment, the wheel seat (5) being appeared in reversed U-shape includes two side sheets (51) and a prop-up surface (52) formed between the side sheets (51).

The resilient element (6) being provided within the containing slot (411) of the shaft rod (41) makes itself move in a direction along the central axis (40) of the shaft rod (41). In the present embodiment, the resilient element (6) being a compression spring or a resilient block and having the prop-up block (61) provided under the resilient element (6) makes itself position between the prop-up surface (52) of the wheel seat (5) and the shaft rod (41) of the shaft-connecting member (4).

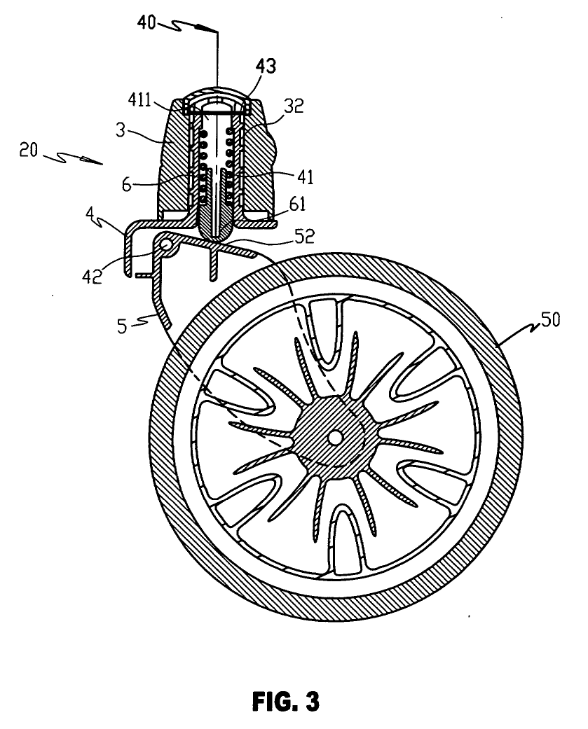

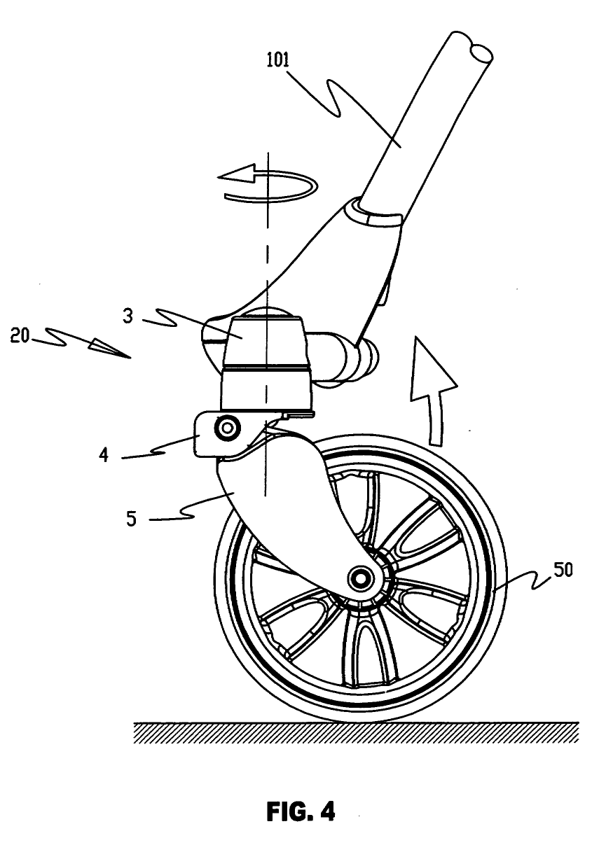

As shown in FIG. 3 and FIG. 4, by the use of the above-mentioned members, since the wheel seat (5) is pivotally connected to the shaft-connecting member (4) that is pivotally connected to the connecting seat (3) successively, the wheel seat (5) is capable of rotating with respect to the central axis (40) of the shaft rod (41). In addition, since the resilient element (6) is installed between the wheel seat (5) and the shaft-connecting member (4) and since the pivotally connecting portion (42) of the pivotally connected wheel seat (5) is offset a certain distance away from the central axis (40) of the shaft rod (41), when the wheel seat (5) rotates with respect to pivotally connecting portion (42) (i.e. when the pushing to the baby stroller comes across a blockade or the baby stroller runs on uneven road surface), the baby stroller is capable of achieving an object of shock-absorbing by the use of the prop-up surface (52) of the wheel seat (5) to prop up to compress the resilient element (6). Moreover, since the resilient element (6) is installed within the shaft rod (41) of the shaft-connecting member (4), the center of rotation of the wheel seat (5) is the central axis (40) which is also the center of the direction that the resilient element (6) moves along. Therefore, the invention is capable of achieving the efficacies of rotating smoothly and having shock absorbing.

It will become apparent to those people skilled in the art that various modifications and variations can be made to the mechanism of the invention without departing from the scope or spirit of the invention. In view of the foregoing description, it is intended that all the modifications and variation fall within the scope of the following appended claims and their equivalents.

What is claimed is:

1. A wheel assembly for baby stroller provided at the lower end of the frame of the baby stroller comprising:
a connecting seat securing at the lower end of the frame of the baby stroller further including a shaft sleeve that is perpendicular to the ground surface;
a shaft-connecting member further including a shaft rod and a pivotally connecting portion wherein the shaft rod is pivotally connected to the shaft sleeve; and the shaft-connecting member rotates with respect to the central axis of the shaft rod; and the pivotally connecting portion is offset a certain distance away from the central axis of the shaft rod; and
a wheel seat for shaft-connecting to the wheel of the baby stroller, the wheel seat is pivotally connected to the pivotally connecting portion of the shaft-connecting member to make the wheel seat rotate with respect to the central axis of the shaft rod; the wheel seat further includes a prop-up surface; and a resilient element is provided between the prop-up surface and the shaft rod; the moving direction of the resilient element is along a central axis of the shaft rod such that when the wheel seat rotates with respect to pivotally connecting portion, the sustained shock of the wheel seat is absorbed through the action that the prop-up surface presses against the resilient element to make the baby stroller structure achieve the effects of being capable of rotating and shock absorbing.

2. The wheel assembly for baby stroller as claimed in claim 1, wherein the connecting seat further includes a connecting portion that is employed to secure to the lower end of either the front foot-tube or the rear foot-tube of the frame of the baby stroller.

3. The wheel assembly for baby stroller as claimed in claim 1, wherein a containing slot for containing the resilient element is provided within the shaft rod of the shaft-connecting member.

4. The wheel assembly for baby stroller as claimed in claim 3, wherein the containing slot is capable of containing the resilient element.

5. The wheel assembly for baby stroller as claimed in claim 1, wherein the resilient element is a compression spring.

6. The wheel assembly for baby stroller as claimed in claim 1, wherein the wheel seat being appear in reversed U-shape is shaft-connected to the wheel through two side sheets.

7. The wheel assembly for baby stroller as claimed in claim 1, wherein the lower end of the resilient element is connected to a prop-up block that is positioned between the resilient element and the prop-up surface of the wheel seat.

8. The wheel assembly for baby stroller as claimed in claim 1, wherein the shaft sleeve is a circular slot.
